(19) United States
(12) Patent Application Publication
(10) Pub. No.: US 2016/0060076 A1
(43) Pub. Date: Mar. 3, 2016

(54) CONTROL USING EXTERNAL DATA

(71) Applicants: Helmut Lothar Schroeder-Brumloop, Berlin (DE); Jeremy Youker, West Hartford, CT (US); Daryl J. Marvin, Farmington, CT (US); Ronnie E. Thebeau, Haddam, CT (US)

(72) Inventors: Helmut Lothar Schroeder-Brumloop, Berlin (DE); Jeremy Youker, West Hartford, CT (US); Daryl J. Marvin, Farmington, CT (US); Ronnie E. Thebeau, Haddam, CT (US)

(21) Appl. No.: 14/785,927

(22) PCT Filed: Apr. 25, 2013
(86) PCT No.: PCT/US2013/038172

§ 371 Date: Oct. 21, 2015

(51) Int. Cl. B66B 1/24; B66B 13/14; G05B 15/02; B66B 1/34

(52) U.S. Cl. CPC B66B 1/2408; B66B 1/3415; B66B 13/146; G05B 15/02; B66B 2201/104; B66B 2201/214; B66B 2201/405

(57) ABSTRACT

Embodiments are directed to receiving, by a controller comprising a processor, data that is external to a conveyance device, processing, by the controller, the external data, and controlling, by the controller, the conveyance device based on the processed external data, wherein the external data comprises at least one of: security management data and emergency services data.

### BACKGROUND

An elevator car may be positioned based on expected or experienced/actual demands. For example, in an office building an elevator controller may cause a greater number of elevator cars to be available in a lobby during early morning hours when employees are expected to first arrive to the office. Similarly, later in the evening, a greater number of elevator cars may be made available at higher-numbered floors of the office building to accommodate the employees leaving the office.

Control exercised over the elevator is merely based on information that is local or internal to the elevator. Greater efficiency in operation could be realized if a greater or large universe of data is used.

### BRIEF SUMMARY

An embodiment of the disclosure is directed to a method comprising: receiving, by a controller comprising a processor, data that is external to a conveyance device, processing, by the controller, the external data, and controlling, by the controller, the conveyance device based on the processed external data, wherein the external data comprises at least one of: security management data and emergency services data.

An embodiment of the disclosure is directed to an apparatus comprising: at least one processor, and memory having instructions stored thereon that, when executed by the at least one processor, cause the apparatus to: receive data that is external to an application environment, process the external data, and control an entity located within the application environment based on the processed external data, wherein the external data comprises at least one of: security management data and emergency services data.

An embodiment of the disclosure is directed to an elevator system comprising: a controller configured to: receive data comprising external data and internal data, and process the data, and an elevator car configured to be controlled by the controller based on the processed data, wherein the external data comprises at least one of: security management data and emergency services data.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more embodiments;

FIG. 2 illustrates an exemplary block diagram of inputs influencing elevator controls in accordance with one or more embodiments; and

FIG. 3 illustrates a flow chart of an exemplary method in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for enhancing or improving operation of an elevator. In some embodiments, data that is external to the elevator may be used to influence the operation of the elevator. As used herein, data is external to an elevator when the data is not specific to the elevator (e.g., when the data is not solely used in connection with the maintenance, use, or construction of the elevator) and when the data is sourced from outside of the environment (e.g., the building) where the elevator is located.

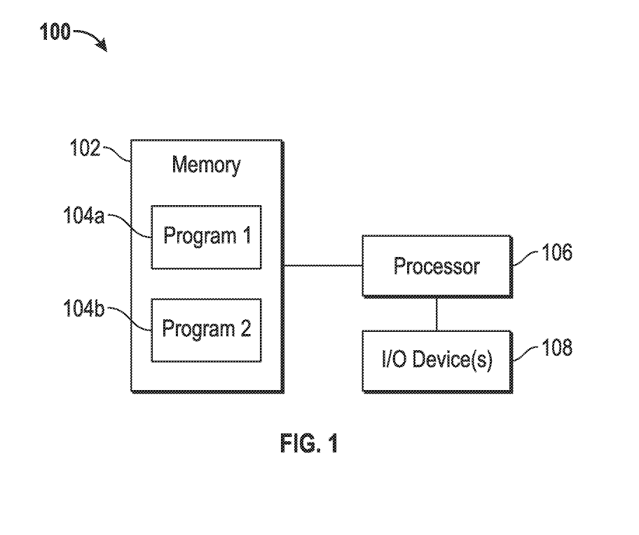

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, procedures, methods, functions, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

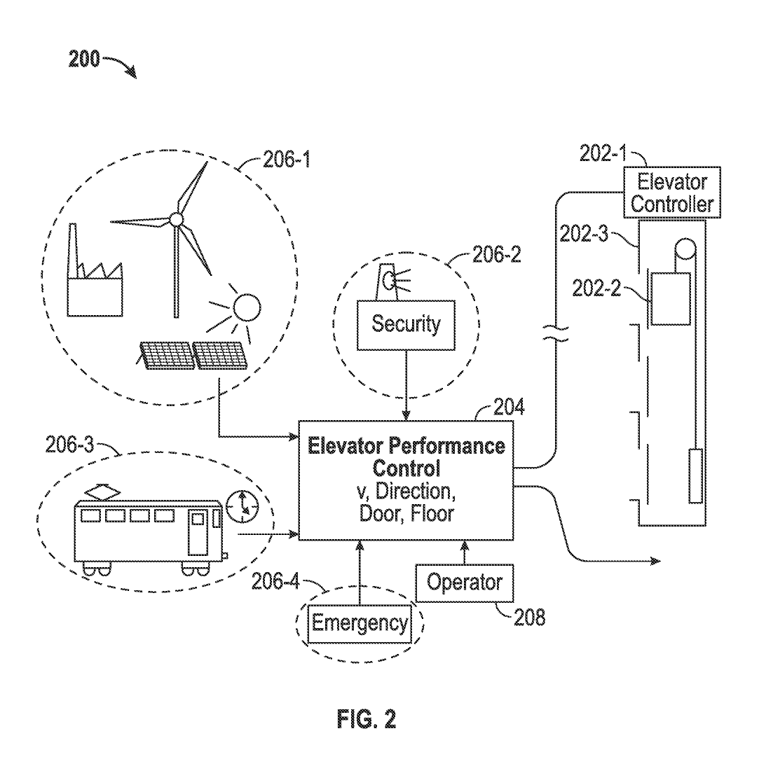

Turning now to FIG. 2, an exemplary block diagram 200 in accordance with one or more embodiments is shown. As shown in FIG. 2, an elevator controller 202-1 may be used to control or adjust one or more operations associated with an elevator. In some embodiments, the controller 202-1 may include one or more components or devices described in connection with the system 100 of FIG. 1.

A subset of controls that may be provided by the controller 202-1 are shown in block 204. For example, the subset of controls 204 may include one or more of a velocity (V) for an elevator car 202-2, a direction the elevator car 202-2 is to travel in (e.g., up or down a hoist-way 202-3), door controls (e.g., door speed when opening or closing), and specification of a landing or floor that the elevator car 202-2 should go to. Other controls may be included, such as elevator car 202-2 acceleration, an ambient temperature for the elevator car 202-2, volume of sounds or music played in the elevator car 202-2, etc.

The controls or commands provided by the controller 202-1 to an elevator or elevator car 202-2 may be a function of one or more inputs. In some embodiments, the one or more inputs may be based on external data. As an example, the external data may include data derived from or obtained from one or more utilities 206-1. The utilities 206-1 may include one or more power utilities. The data obtained from the utilities 206-1 may include pricing of power (e.g., electrical power). The pricing may be based on offer and demand data or statistics regarding actual or expect usage.

Based on the data from the utilities 206-1, operation of the elevator may be adjusted by the controller 202-1. For example, if energy cost is high (relative to a baseline value) as reflected by the data received from the utilities 206-1, then elevator car 202-2 velocity (V) and/or elevator car 202-2 door speed may be adjusted (e.g., reduced relative to a baseline) in order to minimize peak energy demand.

The external data may include data received from one or more entities or agencies associated with security 206-2. For example, the data received from security 206-2 may pertain to police reports or notices, terror alerts, etc.

Based on the data from the security 206-2, operation of the elevator may be adjusted by the controller 202-1. For example, if a warning or alert has been issued, use of the elevator may be limited to specific personal, optionally as a function of one or more credentials (e.g., an RFID-card). If a person riding in an elevator car 202-2 is identified as a suspect or person of interest, the controller 202-1 may cause the elevator car 202-2 to stop between floors or at a particular floor or landing to allow the person to be questioned, examined, or apprehended by security personnel, police, the military, etc.

The external data may include data received from one or more transportation facilities 206-3. For example, the data received from transportation facilities 206-3 may pertain to private (individual) or public transportation (e.g., bus, taxi, train, aircraft, marine craft) information, such as schedules, availability, delays, etc.

Based on the data from the transportation facilities 206-3, an elevator car 202-2 arrival time may be adjusted by the controller 202-1. For example, if the controller 202-1 knows that a user rides the “number 7” train upon leaving the office for the day (potentially based on the user providing such information via, e.g., a mobile device), and the controller 202-1 knows based on data provided by the transportation facilities 206-3 that the number 7 train is running behind schedule that day, the controller 202-1 may prioritize picking up other passengers/users of the elevator relative to the user that rides the number 7 train. Conversely, if the number 7 train is running ahead of schedule, the controller 202-1 may prioritize picking up the user relative to other passengers/users of the elevator in an effort to get the user to the number 7 train before the number 7 train departs the train station.

The external data may include data received from emergency services 206-4. For example, the data received from emergency services 206-4 may include weather information, earthquake alerts, tidal wave or tsunami alerts, fire alerts, evacuation alerts, etc.

Based on the data from the emergency services 206-4, operation of the elevator may be adjusted by the controller 202-1. For example, travel within the elevator may be adjusted to accommodate, e.g., evacuation needs.

Operation of the elevator by the controller 202-1 may be a function of additional data provided by one or more other entities, such as an operator 208. Data provided by the operator 208 may include external data that is not included in the data provided by entities 206-1 through 206-4. Data provided by the operator 208 may include “internal data” or data that has been used by conventional or traditional elevator systems, such as actual or expected demand for the elevator system. Thus, the controller 202-1 may cause the elevator to operate based on a combination of external data and internal data.

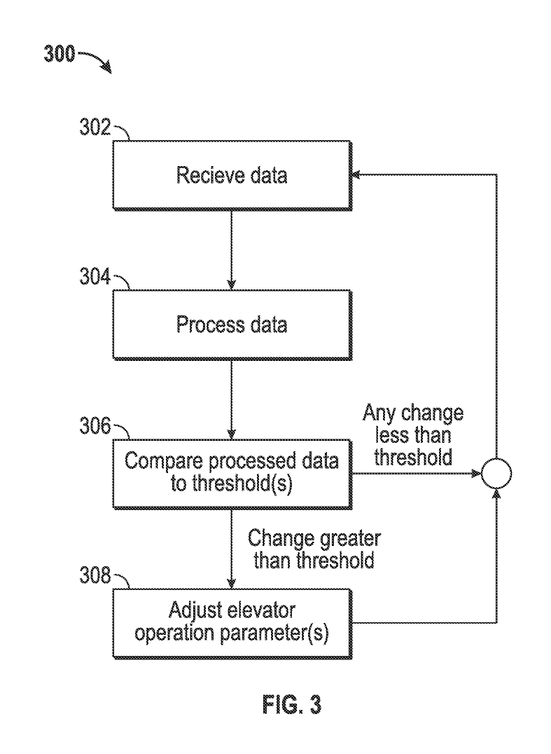

Turning now to FIG. 3, a method 300 is shown. The method 300 may be executed in connection with one or more systems, components, or devices, such as those described herein (e.g., the system 100, the controller 202-1, etc.). The method 300 may be used to control or adjust the operation of an elevator.

In block 302, data may be received. The data source may be one or more of the sources shown in FIG. 2. The data may include internal data and/or external data.

In block 304, the data of block 302 may be processed.

In block 306, the processed data of block 304 may be compared to one or more thresholds.

If in block 306 a determination is made that a change in the data (relative to an initial or baseline value) is greater than a threshold, then one or more parameters that control the operation of the elevator may be adjusted in block 308. From block 308, flow may proceed to block 302, and the data may continue to be received to determine if any additional updates or changes to the operation of the elevator are needed.

If in block 306 a determination is made that any change in the data (relative to an initial or baseline value) is less than (or equal to) a threshold, then the elevator may be operated in accordance with parameters that may have been established prior to the receipt of the data in block 302. In that case, flow may proceed from block 306 to block 302, and the data may continue to be received to determine if any updates or changes to the operation of the elevator are needed.

The method 300 is illustrative. In some embodiments, one or more blocks or operations (or a portion thereof) may be optional. In some embodiments, the blocks may execute in an order or sequence different from what is shown in FIG. 3. In some embodiments, additional blocks not shown may be included.

While some of the examples described herein related to elevators, aspects of this disclosure may be applied in connection with other types of conveyance devices, such as a dumbwaiter, an escalator, a moving sidewalk, a wheelchair lift, etc. In some embodiments, aspects of the disclosure may be applied to other application environments, such as trains, aircraft, marine craft, etc.

Embodiments of the disclosure may be used to enhance or improve the operation of an elevator. In some embodiments, the cost of operating an elevator may be reduced based on the price of power. Performance and timing may be adjusted to accommodate user preferences or schedules. Functionality may be adjusted to support security activities. Operations may be adapted to accommodate environmental circumstances, organizational considerations, or other factors. In some embodiments, a centralized control may be provided to support multiple applications using common algorithms and information/data. Furthermore, provision of a centralized control may be used to make adjustments available and effective to multiple installations maintained or administered by a centralized or common organization/authority.

Embodiments of the disclosure may be tied to one or more particular machines. For example, a controller may be configured to receive data external to an elevator system. The controller may process the data to control or adjust operation of the elevator.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
receiving, by a controller comprising a processor, data that is external to a conveyance device;
processing, by the controller, the external data; and
controlling, by the controller, the conveyance device based on the processed external data,
wherein the external data comprises at least one of: security management data and emergency services data.

2. The method of claim 1, wherein the conveyance device comprises at least one of an elevator, a dumbwaiter, an escalator, a moving sidewalk, and a wheelchair lift.

3. The method of claim 1, wherein the external data comprises transportation data.

4. The method of claim 1, further comprising:
comparing, by the controller, the processed external data to at least one threshold.

5. The method of claim 4, further comprising:
adjusting, by the controller, at least one parameter associated with an operation of the conveyance device when the processed external data exceeds the at least one threshold.

6. The method of claim 1, further comprising:
receiving, by the controller, data that is internal to the conveyance device; and
processing, by the controller, the internal data,
wherein the controlling of the conveyance device is based on the processed internal data.

7. An apparatus comprising:
at least one processor; and
memory having instructions stored thereon that, when executed by the at least one processor, cause the apparatus to:
receive data that is external to an application environment;
process the external data; and
control an entity located within the application environment based on the processed external data,
wherein the external data comprises at least one of: security management data and emergency services data.

8. The apparatus of claim 7, wherein the application environment comprises an elevator, and wherein the external data comprises power utility data, and wherein the instructions, when executed by the at least one processor, cause the apparatus to:
adjust a door speed and a velocity of an elevator car based on the power utility data.

9. The apparatus of claim 7, wherein the application environment comprises an elevator, and wherein the external data comprises security management data, and wherein the instructions, when executed by the at least one processor, cause the apparatus to perform at least one of:
limiting use of the elevator to specified personnel based on the security management data,
stopping an elevator car between floors based on the security management data, and
stopping the elevator car at a specified floor based on the security management data.

10. The apparatus of claim 7, wherein the application environment comprises an elevator, and wherein the external data comprises transportation data, and wherein the instructions, when executed by the at least one processor, cause the apparatus to:
adjust an arrival time of an elevator car based on the transportation data.

11. The apparatus of claim 10, wherein the transportation data comprises public transportation information associated with at least one of a bus, a taxi, an aircraft, and a marine craft.

12. The apparatus of claim 11, wherein the public transportation information comprises at least one of: a schedule, information on availability, and information relating to delays.

13. The apparatus of claim 7, wherein the application environment comprises an elevator, and wherein the external data comprises emergency services data, and wherein the instructions, when executed by the at least one processor, cause the apparatus to:
adjust travel within the elevator based on evacuation needs.

14. The apparatus of claim 7, wherein the instructions, when executed by the at least one processor, cause the apparatus to:
compare the processed external data to at least one threshold; and
adjust at least one parameter associated with an operation of the entity when the processed external data exceeds the at least one threshold.

15. An elevator system comprising:
a controller configured to:
receive data comprising external data and internal data, and process the data; and
an elevator car configured to be controlled by the controller based on the processed data,
wherein the external data comprises at least one of: security management data and emergency services data.

16. The system of claim 15, wherein the external data comprises power utility data, and wherein the controller is configured to adjust a door speed and a velocity of the elevator car based on the power utility data.

17. The system of claim 15, wherein the external data comprises security management data, and wherein the controller is configured to:
limit use of the elevator car to specified RFID-cards based on the security management data,
stop the elevator car between floors based on the security management data, or
stop the elevator car at a specified floor based on the security management data.

18. The system of claim 15, wherein the external data comprises transportation data, and wherein the controller is configured to:
adjust an arrival time of the elevator car to a specified floor based on the transportation data.

19. The system of claim 15, wherein the external data comprises emergency services data, and wherein controller is configured to:
adjust travel within the elevator system based on evacuation needs.

20. The system of claim 15, wherein the internal data comprises actual or expected demand for the elevator system.
